(19) United States
(12) Patent Application Publication
(10) Pub. No.: US 2026/0078730 A1
(43) Pub. Date: Mar. 19, 2026

(54) DUAL LOCKING POSITION REACTIVE, REVERSIBLE BLADE TURBINE SYSTEM FOR ALTERNATIVE ENERGY PRODUCTION

(71) Applicant: Michael Scot Cummings, Walterboro, SC (US)

(72) Inventor: Michael Scot Cummings, Walterboro, SC (US)

(21) Appl. No.: 18/890,021

(22) Filed: Sep. 19, 2024

(51) Int. Cl. F03B 3/12; F03B 11/00; F03B 13/00; F03D 9/00; H02K 7/18

(52) U.S. Cl. CPC F03B 3/12; F03B 11/00; F03B 13/00; F03D 9/008; H02K 7/1823; F05B 2260/31; F05B 2260/95

(57) ABSTRACT

A reactive turbine system provides a turbine having a top support and a bottom support defining a system axis therebetween. The turbine is configured to rotate about the system axis in a flow of fluid, and at least one reactive turbine blade is disposed between the top and bottom supports. The reactive turbine blade is configured for communication with the flow of fluid, and the reactive turbine blade, spinning in a first direction in the flow of fluid, reaches a first locking position and reverses until, spinning in a second, opposing direction, reaches a second locking position and reverses again to spin in the second direction in the flow of fluid. The system further comprises a guard disposed about the turbine configured to spin independently in the flow of fluid. Methods of using the reactive turbine system are also provided herein.

### BACKGROUND OF THE DISCLOSURE

Alternative energy generation is sought for reasons ranging from political to ideological to hoped-for cost reductions. However, known alternative energy sources such as solar and wind, standing alone, have substantial drawbacks. Another source of alternative energy is to harness wave, tidal, and current action. However, there are shortcomings with fixed-blade turbines used in fluids such as air and water.

As such, the present disclosure provides turbine systems designed for energy production using fluid flow. Traditional turbine systems often face limitations in terms of low-flow start-up issues, blade breakage, low efficiency, poor scalability, expensive and complex manufacturing, and poor adaptability to various fluid environments. Conventional designs typically involve unidirectional rotation which fail to adequately harness energy potential of fluid flows that often change direction or have low current speeds.

The present disclosure provides reactive turbine systems comprising a reactive blade turbine with top and bottom supports defining a system axis, and a guard that can rotate independently of the turbine. The reactive turbine blades lock in specific positions, reversing direction to adapt to fluid flow changes, thereby optimizing energy capture. The turbine system is versatile, capable of vertical or horizontal orientation, and operates in various fluid types including but not limited to, water, air, oil, and sewage.

It is, therefore, an object of the present disclosure to provide alternative energy production that maximizes power generation in various fluids through a full, smooth rotation of the turbine and without regard to water flow direction, current speeds, and passing debris.

### SUMMARY OF THE DISCLOSURE

Several devices directed to the present disclosure are disclosed herein. In one embodiment, a device comprises a reactive turbine system. The reactive turbine system comprises a turbine having a top support and a bottom support defining a system axis therebetween, and the turbine is configured to rotate about the system axis in a flow of fluid. The reactive turbine system of the present embodiment further comprises a reactive turbine blade disposed between the top and bottom supports, defining a blade axis, and the reactive turbine blade is configured for communication with the flow of fluid, wherein the reactive turbine blade, spinning in a first direction in the flow of fluid, reaches a first locking position and reverses until, spinning in a second, opposing direction, reaches a second locking position and reverses again to spin in the second direction in the flow of fluid. Further, the reactive turbine system of the present embodiment comprises a guard disposed about the turbine, configured to spin independently in the flow of fluid, the rotations of the guard, the reactive turbine blade, and the turbine cooperating to produce electrical energy.

Methods of using a reactive, reversible blade turbine system are also provided herein. In one embodiment, the reactive, reversible blade turbine system is employed for electrical energy production. In this embodiment, a method of using the reactive, reversible blade turbine system comprises deploying the turbine system in a flow of fluid, generating electrical energy from the flow of fluid and turbine system via a power generator, and transferring the electrical energy to a connected energy conversion system, the connected energy conversion system selected from the group consisting of a battery, electric grid, portable electronic device, and combinations thereof.

Other embodiments include the foregoing and other elements and steps described herein, and their equivalents, in various combinations. Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification. All examples are therefore non-limiting.

### BRIEF DESCRIPTION OF THE DRAWINGS

A full and enabling disclosure of the present subject matter, including the best mode thereof, directed to one of ordinary skill in the art, is set forth in the specification, which refers to the appended figures, in which:

FIG. 1 shows a top-down view of a reactive turbine system in one embodiment.

FIG. 2 shows a perspective view of a reactive turbine system oriented vertically in one embodiment.

FIG. 3 shows a perspective view of a reactive turbine system oriented vertically in an alternate embodiment.

FIG. 4 shows a top-down view of a reactive turbine system in an alternate embodiment.

FIG. 5 shows a right-side perspective view of a reactive turbine system oriented horizontally in one embodiment.

FIG. 6 shows a perspective view of a reactive turbine system comprising an integrated power generator in one embodiment.

FIG. 7A shows a plan view of a reactive turbine system comprising a trailer.

FIG. 7B shows a first side view of the reactive turbine system of FIG. 7A.

FIG. 8 shows a plan view of a reactive turbine system comprising hollow members.

FIG. 9 shows a perspective view of a reactive turbine system comprising a guard in one embodiment.

FIG. 10 shows a top-down illustrative view of a reactive turbine system in one embodiment.

### DETAILED DESCRIPTION

As required, detailed embodiments of the present disclosure are provided herein; however, it is to be understood that the disclosed embodiments are merely examples of the present disclosure that may be embodied in various forms. The figures are not necessarily to scale, and some features may be exaggerated to show details of particular elements. Therefore, specific structural and functional details disclosed herein are not to be interpreted as limiting, but merely as a basis for the claims and as a representative basis for teaching one skilled in the art to variously employ the present disclosure.

Unless defined otherwise, all technical and scientific terms used herein have the same meaning as is commonly understood by one of ordinary skill in the art to which this disclosure belongs. In the event that there are a plurality of definitions for a term herein, those in this disclosure prevail unless stated otherwise.

Wherever the phrase “for example,” “such as,” “including,” and the like are used herein, the phrase “and without limitation” is understood to follow unless explicitly stated otherwise. Similarly, “an example,”“exemplary,”and the like are understood to be non-limiting.

The term “substantially” allows for deviations from the descriptor that do not negatively impact the intended purpose. Descriptive terms are understood to be modified by the term “substantially”even if the word “substantially”is not explicitly recited.

The term “about,” when used in connection with a numerical value, refers to the actual given value, and to the approximation to such given value that would reasonably be inferred by one of ordinary skill in the art, including approximations due to the experimental and/or measurement conditions for such given value.

The terms “comprising,” “including,” “having,” “involving” (and similarly “comprises,” “includes,” “has,” and “involves”), and the like are used interchangeably and have the same meaning. Specifically, each of the terms is defined consistent with the common United States Patent Law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b, and c. Similarly, the phrase “a method involving steps a, b, and c” means that the method includes at least steps a, b, and c.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to. ”

Any discussion of the prior art throughout the specification should in no way be considered as an admission that such prior art is widely known or forms part of common, general knowledge in the field.

The various embodiments of the disclosure and/or equivalents falling within the scope of the present disclosure overcome or ameliorate at least one of the disadvantages of the prior art or provide a useful alternative.

The present disclosure relates generally to a reactive turbine system using a turbine blade for alternative energy production, in addition to or alternatively, for pumping fluids and producing mechanical energy. More particularly, the present disclosure relates to a reactive turbine system with first and second locking positions. Further still, the present disclosure relates to a reactive turbine system that operates vertically, horizontally, clockwise, or counterclockwise in a flow of fluid in which the turbine blade rotates 360 degrees about a blade axis between the first locking position and the second, opposing locking position.

In one embodiment, a reactive turbine system is provided. The reactive turbine system of the present embodiment comprises a turbine having a top support and a bottom support defining a system axis therebetween. The turbine is configured to rotate about the system axis in a flow of fluid, and a reactive turbine blade is disposed between the top and bottom supports, defining a blade axis. The reactive turbine blade is configured for communication with the flow of fluid, wherein the reactive turbine blade, spinning in a first direction in the flow of fluid, reaches a first locking position and reverses until, spinning in a second, opposing direction, reaches a second locking position and reverses again to spin in the second direction in the flow of fluid. The reactive turbine system of the present embodiment further comprises a guard disposed about the turbine and configured to spin independently in the flow of fluid. The rotations of the guard, the reactive turbine blade, and the turbine cooperate to produce electrical energy. Alternatively or in conjunction with producing electrical energy, the presently disclosed reactive turbine system may be capable of producing mechanical energy and pumping fluids.

In the present embodiment, the reactive turbine blade may be configured to extend through the top and bottom supports to increase support and control of the reactive turbine blade.

The turbine system may be oriented vertically, or alternatively, the turbine system may be oriented horizontally with respect to the flow of fluid. Orientation of the turbine system may be dictated by a depth of the fluid, a speed of the fluid, and/or size constraints placed on the reactive turbine system by a given environment of operation.

In the present embodiment, the reactive turbine blade may further comprise a plurality of reactive turbine blades. The plurality of reactive turbine blades of the present embodiment may be disposed between the top and bottom supports and define individual or combined blade axes. The reactive turbine blade, whether singularly or as the plurality, creates a star-pattern over time as the reactive turbine blade rotates to produce electrical energy in the flow of fluid.

The reactive turbine blade may further be enlarged via a removably attachable member capable of increasing an area of the reactive turbine blade. Advantageously, enlarging the reactive turbine blade permits the reactive turbine blade to capture more energy from the flow of fluid, resulting in an increased speed of rotation and/or an increased amount of rotational torque applied to the reactive turbine blade. Both increased speed of rotation and increased rotational torque increase an amount of electrical energy capable of being produced by the reactive turbine system.

Further, a thickness of the reactive turbine blade may be configurable, meaning that the thickness may be manipulated, either during construction or after installation, to be larger or smaller than initially designed to meet electrical energy demand and/or to operate efficiently in the flow of fluid based on changing speeds, flow rates, quantities, etc.

For example, a number and a size of the plurality of reactive turbine blades may be decreased as a depth of the fluid increases. As the depth of the fluid increases, relative pressure and speed of the flow of fluid increases. To operate efficiently, the reactive turbine system and its respective turbine blades may be altered, manipulated, and/or adjusted with respect to size, number, configuration, and/or orientation.

Alternatively, the number and size of the plurality of reactive turbine blades may be increased as a depth of the fluid decreases. As the depth of the fluid decreases, relative pressure and speed of the flow of fluid decreases. To operate efficiently, the reactive turbine system and its respective turbine blades may be altered, manipulated, and/or adjusted with respect to size, number, configuration, and/or orientation.

In an alternate embodiment, for example, the number and size of the plurality of reactive turbine blades may be decreased as the speed of the flow of fluid increases. Alternatively, the number and size of the plurality of reactive turbine blades may be increased as the speed of the flow of fluid decreases.

In one embodiment, the reactive turbine blade is flat. In an alternate embodiment, the reactive turbine blade may be curved, substantially planar, convex, concave, or corrugated. A shape of the reactive turbine blade is configurable based on several factors including but not limited to, pressure exerted by the fluid, the speed of the flow of fluid, a desired electrical output of the reactive turbine system, and desired efficiencies at which the reactive turbine system is designed to operate.

In a further embodiment, the reactive turbine blade may be equipped with magnetic cushioning to control rotation and prevent collision with the turbine system. In this embodiment, one or more magnetized materials may be affixed to the reactive turbine blade and/or the reactive turbine system. As the turbine blade rotates in the flow of fluid and approaches a locking position, either the first or second locking position, like polarities of the magnetized materials repel the reactive turbine blade from the reactive turbine system, preventing unwanted contact between components. Advantageously, magnetic cushioning may serve to assist in reversing the reactive turbine blade, as a repelling force between like poles of magnets assists in changing the direction of rotation of the reactive turbine blade.

In one embodiment, the reactive turbine blade may be hollow and comprise internal framing. In this embodiment, the reactive turbine blade may be substantially lighter than that of a solid turbine blade, thereby permitting faster rotation, increased efficiencies, and increased electrical energy production capabilities of the reactive turbine system. To support the reactive turbine blade, internal framing may be included. Additionally, the hollow regions of the reactive turbine blades may alternatively be filled with dense materials, such as lead, other metals, or aqueous solutions, to either retard the speed of rotation of the reactive turbine blades, and alternatively or in addition, to add ballast to the reactive turbine system.

The reactive turbine blade is capable of rotating 360 degrees about its blade axis between the first locking position and the second, opposing locking position. Advantageously, rotating 360 degrees about its blade axis allows the reactive turbine blade to capture a greater amount of potential energy from the flow of fluid when compared to a system that restricts blade angles. Both a design and operation of the reactive turbine system are influenced by blade angles of the reactive turbine blade. Blade angles affect a hydrodynamic performance of the reactive turbine system by modifying lift, drag, and torque coefficients at various Tip Speed Ratios (“TSRs”). For example, as a blade angle of the reactive turbine system increases, an optimal power coefficient (Cₚ) shifts to a higher TSR, indicating enhanced performance at increased rotational speeds. Variable blade angles and capabilities of the reactive turbine blade, including an ability to rotate 360 degrees about its blade axis between the first locking position and the second, opposing locking position, further permits customizability of the reactive turbine system relative to a given environment of use. For example, in slow-moving fluid flows, a lower blade angle may be advantageous to maximize drag-based energy conversion, whereas in fast-moving fluid flows, a higher blade angle may be advantageous to optimize a lift-to-drag ratio. The first and second locking positions are capable of controlling the blade angles of the reactive turbine blade. The first and second locking positions may be adjusted to predetermined positions to set the blade angles of the reactive turbine blade for specific design, operational, and/or environmental requirements. The first and second locking positions operate by either permitting or restricting a range of motion of the reactive turbine blade as the reactive turbine blade rotates about its blade axis. As such, the presently disclosed reactive turbine system contemplates all blade angles between 0 degrees and 360 degrees relative to both the first locking position and the second, opposing locking position.

Stated differently, the reactive turbine blade, when spinning in the first direction in a hydraulically balanced neutral position, places little to no drag on the reactive turbine blade against an inflow of fluid into the turbine until the reactive turbine blade reaches a first forcing rotational angled locking position. Once the reactive turbine blade reaches the first forcing rotational angled locking position, the system axis of the reactive turbine system continues to rotate 360 degrees until the reactive turbine blade senses an opposing drag on an opposite side of the reactive turbine blade, at which time, the reactive turbine blade reverses and locks in a second forcing rotational angled locking position. From the second forcing rotational angled locking position, the reactive turbine blade begins to rotate in the second, opposing direction out of a sweep area of the flow of fluid while creating over 220 degrees of rotational angled forces. As the reactive turbine blade continues to rotate and senses opposing forces on the first and a second side of the reactive turbine blade, the reactive turbine blade begins rotating back into the hydraulically balanced neutral position to return to the first locking position. Advantageously, the rotation of the reactive turbine blade between the first locking position and the second locking position eliminates considerable drag on the reactive turbine blade and permits 360 degrees of rotation about the respective blade axis in both the first direction and the opposing, second direction.

In a further embodiment, the reactive turbine blade is removably attachable to the turbine system. In this embodiment, the turbine system is portable and deployable by attaching the reactive turbine blade at a desired location. This embodiment of the reactive turbine system and respective reactive turbine blade permits onsite deployment, increased portability, and reduces input needed to transport and deploy the system. Further, this embodiment permits creation and deployment of reactive turbine systems ranging from backpack-sized to trailer-mounted to free-standing configurations. Such systems may be used in remote locations where energy production is difficult. Further, such systems may be used by campers, outdoor enthusiasts, humanitarian missions, and militaries for onsite and/or remote energy production. The reactive turbine system is thus scalable based on numerous factors such as weight, transportability, energy demands, and deployment means.

In one embodiment, the turbine system alternatingly rotates in clockwise and counterclockwise directions about the system axis. In an alternate embodiment, the turbine system alternatingly rotates in counterclockwise and clockwise directions about the system axis. Clockwise and counterclockwise directions of rotation about the system axis are relative to the orientation of the reactive turbine system. As stated previously, the reactive turbine system may be oriented vertically or horizontally in the flow of fluid.

In a preferred embodiment, the rotation of the reactive turbine blade about the system axis produces electrical power. In an alternate embodiment, the rotation of the reactive turbine blade about the system axis pumps fluid, such as, fluid selected from the group consisting of water, air, sewage, oil, steam, and combinations thereof.

In one embodiment, the turbine system is connectable to a battery. The turbine system of the present embodiment produces electrical power when rotated by the flow of fluid and the electrical power may be stored in the battery. The battery may be portable or permanently affixed at a given location. In either embodiment, the battery may be further connectable to a device, electrical grid, or other electrical energy consumption or distribution device.

In an alternate embodiment, the turbine system is connectable to a power grid. The turbine system of the present embodiment produces electrical power when rotated by the flow of fluid and the electrical power may be transmitted to the power grid. The power grid may either be located proximate the reactive turbine system or at a distance away from the reactive turbine system. In either embodiment, the electrical energy produced by the reactive turbine system is first transmitted to the power grid, and the power grid further distributes or consumes the electrical power.

In a further embodiment, the turbine system is directly connectable to a portable electronic device. The turbine system of the present embodiment produces electrical power when rotated by the flow of fluid and the electrical energy may be transmitted to the portable electronic device. Non-limiting examples of the portable electronic device include cellphones, tablets, radios, pumps, motors, appliances, etc. In this embodiment, the reactive turbine system is capable of meeting or exceeding the electrical energy demands of the portable electronic devices and may be employed in remote or onsite locations at which electrical energy is difficult to produce.

In an alternate embodiment of the presently disclosed subject matter, the turbine system is capable of compressing and/or pumping fluid. In this embodiment, the fluid is stored in a storage tank, and the fluid retains potential energy convertible to electrical energy at a specified time. Such fluid may be used to further rotate the reactive turbine system, may be pumped from the storage tank to an alternate electrical energy production device, or may be consumed directly via an alternate device such as a hydrogen generator, freshwater desalinator, etc.

In the present embodiment, the flow of fluid may be selected from the group consisting of water, air, sewage, oil, steam, and combinations thereof. In select embodiments, the flow of fluid may be a combination of the above-mentioned fluids, such that the fluids work together to rotate the reactive turbine system. Additionally, in one embodiment of the reactive turbine system, the turbine system may be further capable of operating under ice. Advantageously, operation under ice further increases locations at which the reactive turbine system may be deployed and assists in remote and onsite energy production.

Turning back to the turbine system, the turbine system may be comprised of a material selected from the group consisting of plastics, fabrics, ultra-high-molecular-weight polyethylene (“UHMW”), metals, composites, wood, and combinations thereof.

Turning back to the top and bottom supports of the present embodiment, the top support and the bottom support may provide the first locking position of the reactive turbine blade. In addition or alternatively, the top support and the bottom support may provide the second locking position of the reactive turbine blade. The top and bottom supports may be constructed from any suitable material which provides support, rigidity, and desired weight characteristics to permit efficient operation of the reactive turbine system. In an alternate embodiment, the guard disposed about the turbine system rotates with the turbine system and provides an alternate, second locking position for the reactive turbine blade. Further, the guard disposed about the turbine system may serve to prevent debris, such as refuse, organic matter, and other suspended media, from entering the turbine system.

In one embodiment, the top support is disposed above a fluid level and the bottom support is disposed below the fluid level. In this embodiment, the reactive turbine system further comprises a slip ring disposed between the top support and bottom support. The slip ring permits independent rotation of the top support and bottom support. Furthermore in the present embodiment comprising the slip ring, the top support, disposed above the fluid level, is rotated via air, and the bottom support, disposed below the fluid level, is rotated via water. In the present or an alternate embodiment, the reactive turbine system may further comprise one or more intermediate supports. The one or more intermediate supports may be disposed between the top support and the bottom support. Further, the one or more intermediate supports may serve as both or either the first or second locking positions for the reactive turbine blade.

In a further embodiment, a perimeter of the top support and bottom support may further comprise a toothed gear. The toothed gear of the top support and the toothed gear of the bottom support may rotate about the system axis and mate with one or more secondary gears to provide rotation to an external power generator affixed to the one or more secondary gears. In this embodiment, the toothed gears of the top support and/or the bottom support provide direct coupling to one or more external power generators affixed to the one or more secondary gears. Similar to a power take-off (“PTO”) generator, the toothed gears of the top and bottom supports permit auxiliary power generators, appliances, components, and/or devices to couple directly to the reactive turbine system and harness rotational energy produced by the reactive turbine system via the flow of fluid to operate.

In one embodiment of the present disclosure, the reactive turbine system further comprises cathodic protection to inhibit corrosion of the turbine system. In this or an alternate embodiment, the cathodic protection comprises zinc anodes affixed to the turbine system to inhibit corrosion. In a further embodiment, galvanic anode cathodic protection (“GACP”) may be used to inhibit corrosion of the turbine system.

In one embodiment, the system axis may further comprise an integral electrical power generator. In this embodiment, the integral electrical power generator may be positioned within the system axis. In an alternate embodiment, the integral electrical power generator may be affixed proximate the reactive turbine system. In either embodiment, the integral electrical power generator is capable of converting the rotational energy produced by the reactive turbine system into electrical energy for storage, consumption, and distribution.

In another embodiment, the system axis may further comprise a hollow, annular region. In this embodiment, the hollow, annular region of the system axis may receive ballast selected from the group consisting of helium, pressurized air, foam, water, lead, and combinations thereof. In an alternate embodiment and as described above, the hollow annular region of the system axis may house the integral electrical power generator.

In a further embodiment, the reactive turbine system may further comprise hollow framing members. In this embodiment, the hollow framing members may receive ballast selected from the group consisting of helium, pressurized air, foam, water, lead, and combinations thereof.

In a further embodiment of the reactive turbine system, the turbine system may further comprise one or more stages. In this embodiment, the one or more stages may be separated by respective slip rings to permit independent rotation of the one or more stages. In this or an alternate embodiment, the one or more stages may be stackable. Furthermore, the one or more stages may be increased, decreased, manipulated, stacked, etc. to configure the reactive turbine system relative to the desired electrical output, sizing constraints, and/or desired efficiencies of operation of the reactive turbine system. Stackability of the one or more stages is further advantageous in transportation and deployment of the reactive turbine system.

In one embodiment, the turbine system is portable. Furthermore, in one embodiment of the portable turbine system, the turbine system is portable via a trailer, wherein the turbine is affixed to the trailer and transported to a location via a vehicle.

In an alternate embodiment of the portable turbine system, the turbine system may be integral to the trailer, wherein the turbine system and trailer are deployable in the fluid to produce electrical power. In this embodiment, the trailer may be self-buoyant.

Methods of using a reactive, reversible blade turbine system are also provided herein. In one embodiment, the method of using a reactive, reversible blade turbine system for electrical energy production first comprises deploying the turbine system in a flow of fluid. The turbine system may further comprise a turbine having a top support and a bottom support defining a system axis therebetween. The turbine may be further configured to rotate about the system axis in the flow of fluid, and a reactive turbine blade may be disposed between the top and bottom supports, defining a blade axis. Further, the reactive turbine blade may be configured for communication with the flow of fluid, wherein the reactive turbine blade, spinning in a first direction in the flow of fluid, reaches a first locking position and reverses until, spinning in a second, opposing direction, reaches a second locking position and reverses again to spin in the second direction in the flow of fluid. The present embodiment may further comprise a guard disposed about the turbine configured to spin independently in the flow of fluid. The rotations of the guard, the reactive turbine blade, and the turbine cooperate to produce electrical energy, generating electrical energy from the flow of fluid and turbine system via a power generator. The method may further comprise transferring the electrical energy to a connected energy conversion system, wherein the connected energy conversion system is selected from the group consisting of a battery, electric grid, portable electronic device, and combinations thereof.

In a further method of using the reactive, reversible blade turbine system for electrical energy production, the reactive turbine blade may further comprise a plurality of reactive turbine blades.

The method of using the reactive, reversible blade turbine system for electrical energy production may further comprise attaching zinc anodes to the turbine system to provide cathodic protection to inhibit corrosion.

The method of using the reactive, reversible blade turbine system for electrical energy production may further comprise adjusting a size, shape, configuration, and number of the plurality of reactive turbine blades relative to a speed and type of the flow of fluid.

The method of using a reactive, reversible blade turbine system for electrical energy production may further comprise adjusting buoyancy of the turbine system via ballast removably insertable in hollow framing of the turbine system.

The method of using a reactive, reversible blade turbine system for electrical energy production may further comprise employing magnetic cushioning to control rotation and prevent unwanted collision of the reactive turbine blade with the turbine system.

The method of using a reactive, reversible blade turbine system for electrical energy production may further comprise deploying additional stages of the turbine system, each stage capable of independent rotation via slip rings to enable relative rotation between the stages.

### DETAILED DESCRIPTION OF THE DRAWINGS

Further embodiments of the present disclosure can be described by reference to the accompanying drawings. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

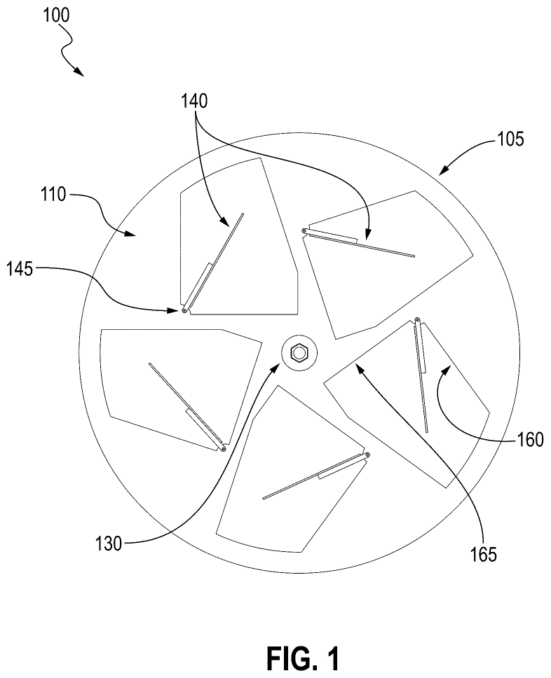

FIG. 1 shows a top-down view of a reactive turbine system 100 in one embodiment. The reactive turbine system 100 of the present embodiment first comprises a turbine 105. The turbine 105 has a top support 110. The top support 110 in the present embodiment is substantially circular and comprises a first cut-out to which the system axis, or shaft, 130 interfaces as well as a plurality of cut-outs to which the one or more reactive turbine blades 140 interface. Further, the plurality of cut-outs of the top support 110 may also embody a first locking position 160 and a second locking position 165. The first and second locking positions 160, 165, constrain the one or more reactive turbine blades 140 as the system 100 rotates about the system axis 130. Further, each of the one or more reactive turbine blades 140 is disposed about a respective blade axis 145.

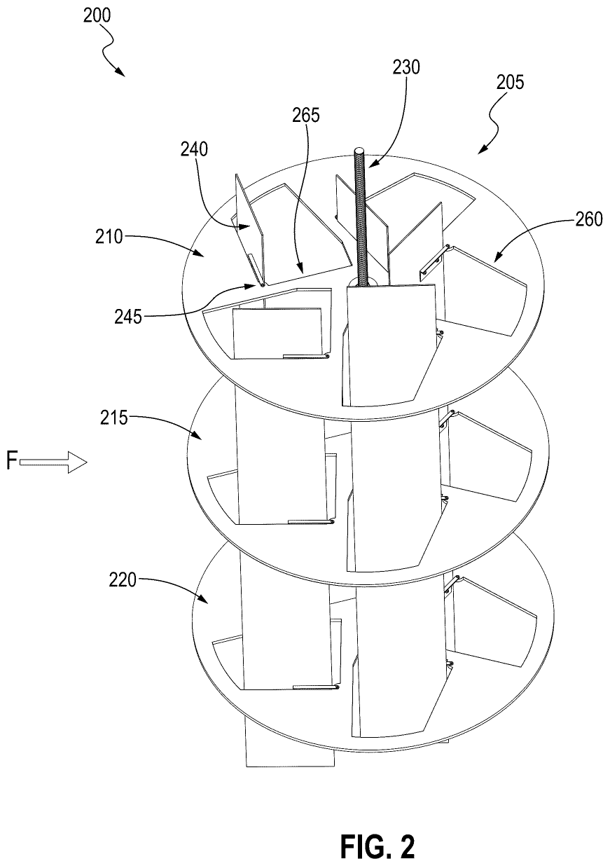

FIG. 2 shows a perspective view of a reactive turbine system 200 oriented vertically in one embodiment. In the present embodiment, the reactive turbine system 200 comprises a turbine 205. The turbine 205 further comprises a top support 210, an intermediate support 215, and a bottom support 220. A system axis 230 extends through the supports 210, 215, 220 and serves as a shaft for the system 200. The turbine 205 further comprises one or more reactive turbine blades 240, each of the one or more reactive turbine blades 240 disposed on a respective blade axis 245. Furthermore, the one or more reactive turbine blades 240 are disposed between a first locking position 260 and a second locking position 265. The one or more reactive turbine blades 240 rotate between the first and second locking positions 260, 265 when acted upon by a flow of fluid F. In this embodiment, the supports 210, 215, 220 comprise cut-outs through which the one or more reactive turbine blades 240 pass. The one or more reactive turbine blades 240 may comprise a single material or may comprise a plurality of materials joined together to form elongated reactive turbine blades 240.

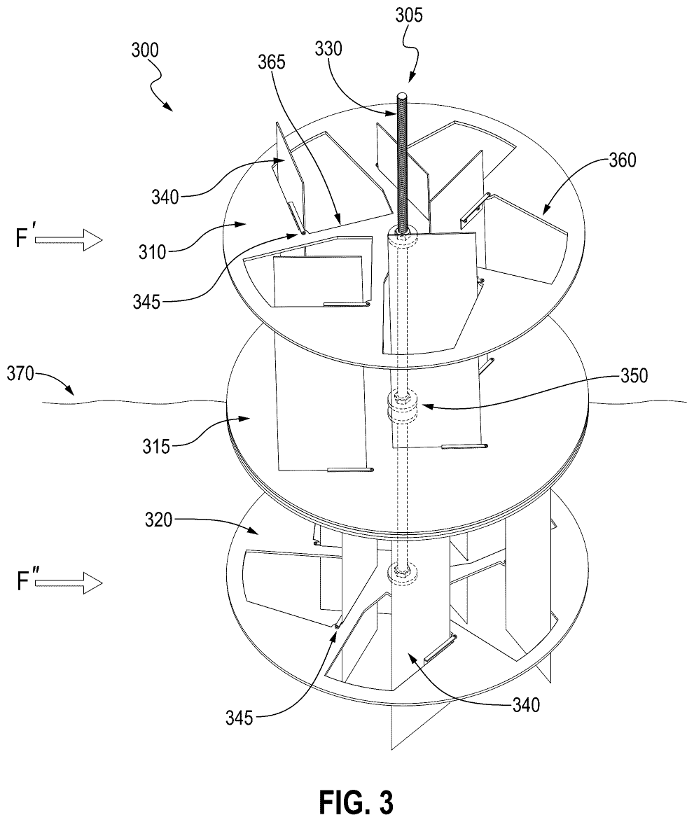

FIG. 3 shows a perspective view of a reactive turbine system 300 oriented vertically in an alternate embodiment. In this embodiment, the reactive turbine system 300 comprises a turbine 305. The turbine 305 further comprises a top support 310, an intermediate support 315, and a bottom support 320. A system axis 330 extends through the supports 310, 315, 320 and serves as a shaft for the system 300. The turbine 305 further comprises one or more reactive turbine blades 340, each of the one or more reactive turbine blades 340 disposed on a respective blade axis 345. Furthermore, the one or more reactive turbine blades 340 are disposed between a first locking position 360 and a second locking position 365. The one or more reactive turbine blades 340 rotate between the first and second locking positions 360, 365. In contrast to the previous embodiment, the reactive turbine system 300 is separated by a fluid level 370. In this embodiment, the fluid level 370 describes a separation between a first flow of fluid F′ and a second flow of fluid F″. For instance, F′ may comprise air, whereas F″ may comprise water, and as such, the fluid level 370 describes the separation between air and water. Furthermore, the intermediate support 315 is substantially solid and comprises a pass-through for the system axis 330. The system axis 330 of the present embodiment comprises two ends separated by a slip ring 350, or shaft coupler (shown in phantom). The slip ring 350 permits independent rotation of the system 300 disposed above and below the fluid level 370. In this embodiment, the system axis 330 may be connected to a power generator or may serve as a pump shaft for pumping fluids.

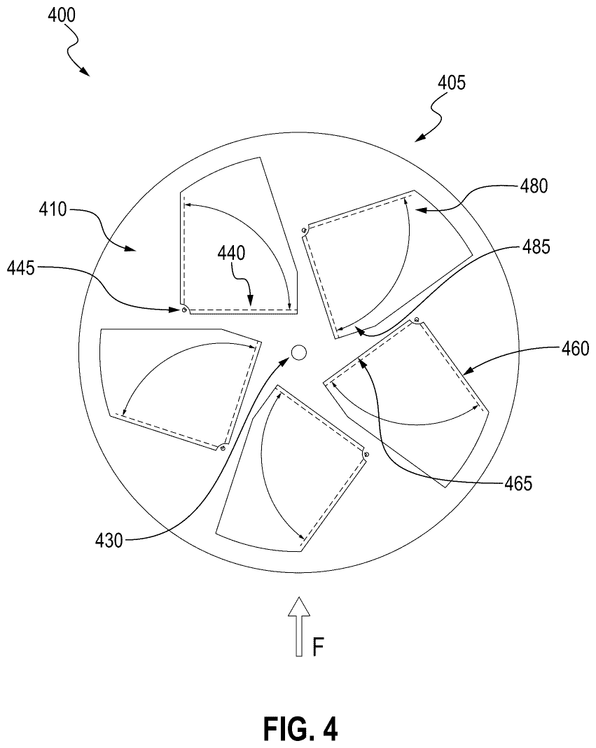

FIG. 4 shows a top-down view of a reactive turbine system 400 in an alternate embodiment. In the present embodiment, the reactive turbine system 400 comprises a turbine 405. The turbine 405 further comprises a top support 410, a system axis 430, one or more reactive turbine blades 440, and respective blade axes 445 for each of the one or more reactive turbine blades 440. The top support 410 further comprises a first locking position 460 and a second locking position 465 within which the one or more reactive turbine blades 440 alternate. The flow of fluid F is also shown. Turning to the one or more reactive turbine blades 440, FIG. 4 illustrates an operation of the one or more reactive turbine blades 440 when acted upon by the flow of fluid F. In this embodiment, the system 400 rotates about the system axis 430, with the one or more reactive turbine blades 440 rotating in a first direction 480. Once the system 400 rotates to a predetermined orientation, the one or more reactive turbine blades 440 contact the first locking position 460 and reverse rotation to rotate in a second direction 485. As the system 400 continues to rotate, the one or more reactive turbine blades 440, now rotating in the second direction 485, contact the second locking position 465 and reverse.

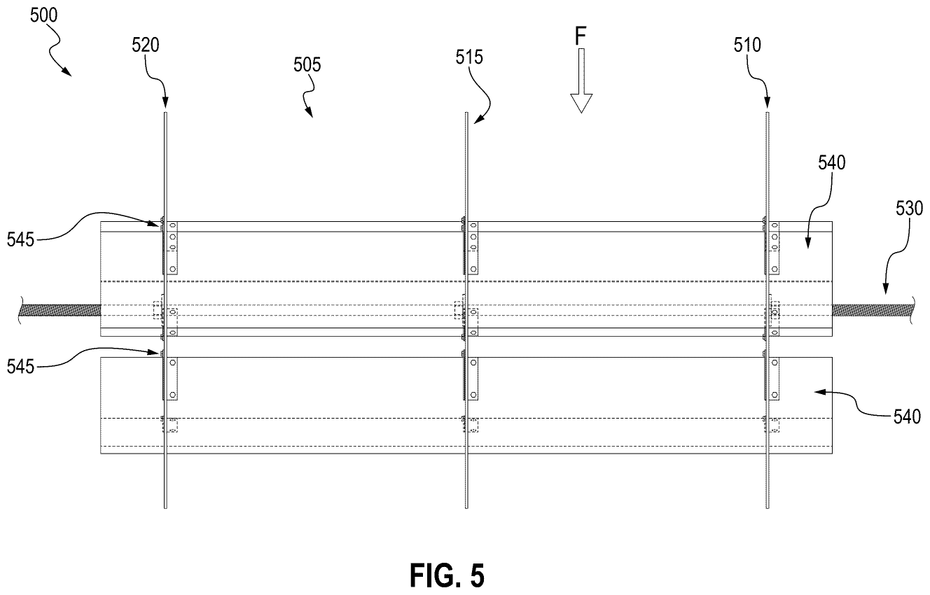

FIG. 5 shows a right-side perspective view of a reactive turbine system 500 oriented horizontally in one embodiment. In this embodiment, the system 500 is oriented horizontally in the flow of fluid F. The system 500 comprises a turbine 505, the turbine 505 further comprising a top support 510, an intermediate support 515, and a bottom support 520 through which a system axis 530 interfaces. The turbine 505 additionally comprises one or more reactive turbine blades 540 disposed about a respective blade axis 545. As previously stated, the turbine system 500 may be oriented vertically, or alternatively, the turbine system 500 may be oriented horizontally with respect to the flow of fluid F. Orientation of the turbine system 500 may be dictated by a depth of the fluid, a speed of the fluid, and/or size constraints placed on the reactive turbine system 500 by a given environment of operation.

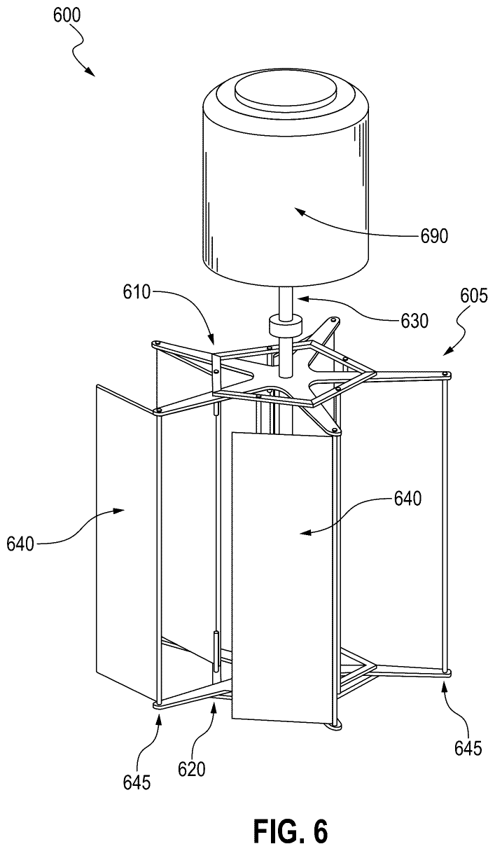

FIG. 6 shows a perspective view of a reactive turbine system 600 comprising an integrated power generator 690 in one embodiment. In the present embodiment, the reactive turbine system 600 further comprises a turbine 605, wherein the turbine 605 further comprises a top support 610, a bottom support 620, and a system axis 630. As stated previously the system axis 630 passes through the top support 610 and the bottom support 620 and may alternatively be referred to as a shaft. In FIG. 6, the intermediate support 215, 315, 515 has been removed from the system 600. The turbine 605 of the present embodiment additionally comprises one or more reactive turbine blades 640 which may be in accordance with reactive turbine blades previously described. The reactive turbine blades 640 engage with the flow of fluid F (not shown in FIG. 6) to rotate the turbine 605 about its system axis 630. Furthermore, the one or more reactive turbine blades 640 alternatingly rotate about respective blade axes 645. Similar to previous embodiments, the present system 600 is capable of generating electrical energy via rotation in the flow of fluid F and the integrated power generator 690. The integrated power generator 690 may be in accordance with any known electrical generator and may be disposed above a fluid level 370, such as fluid level 370 of FIG. 3. The integrated power generator 690 may also be disposed on the system axis 630 between the top support 610 and the bottom support 620. In this instance, the integrated power generator 690 may comprise a sealed, or hermetic, power generator capable of withstanding fluid environments. The integrated power generator 690 transmits electrical power generated by the system 600 to an end device such as a battery, an electric grid, a portable electronic device, a pump, and combinations thereof.

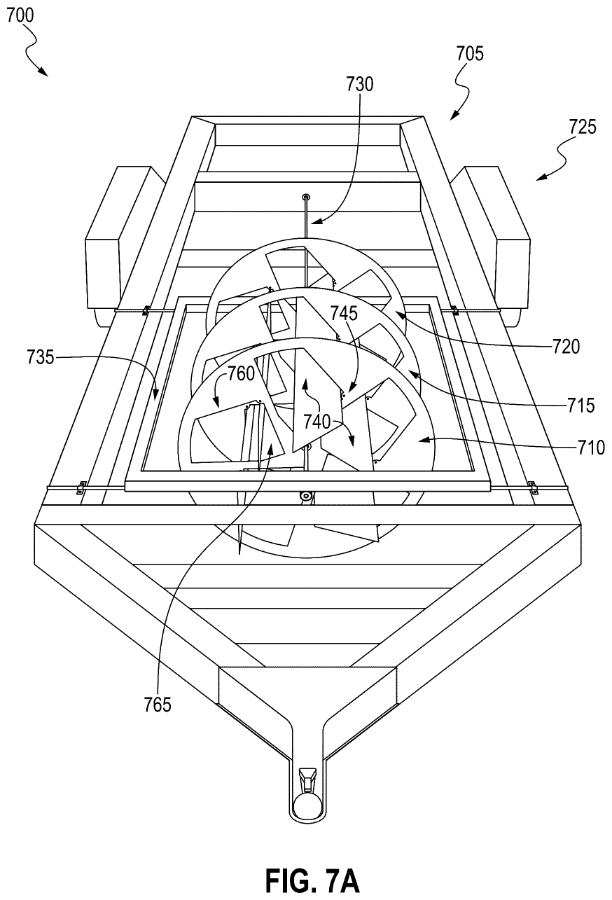

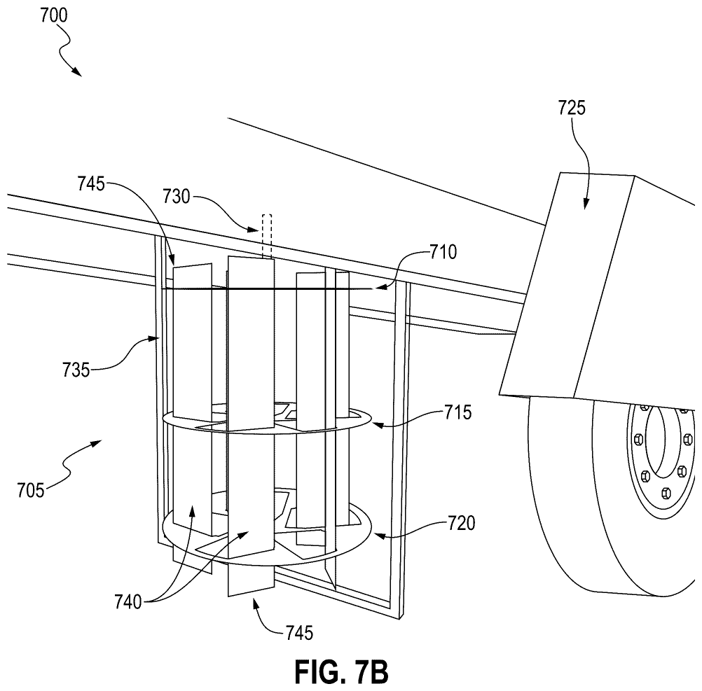

FIG. 7A shows a plan view of a reactive turbine system 700 comprising a trailer 725. In the present embodiment, the turbine system 700 comprises a turbine 705 and the trailer 725. The turbine 705 further comprises a top support 710, an intermediate support 715, and a bottom support 720. FIG. 7A shows the reactive turbine system 700 integrally disposed within the trailer 725 oriented horizontally. This configuration can be a transport configuration or a deployment configuration depending on the fluid environment. Like previous embodiments, the turbine 705 further comprises a system axis 730 about which the turbine 705 rotates and one or more reactive turbine blades 740. The one or more reactive turbine blades further rotate about respective blade axes 745. In this embodiment, a first locking position 760 and a second, opposing locking position 765 are shown. As stated previously, the one or more reactive turbine blades 740 alternatingly rotate between the first and second locking positions 760, 765 when subjected to the fluid environment, the system 700 functioning to generate electrical energy and/or pump fluid. Additionally, the turbine 705 of FIG. 7A is disposed within a frame 735. The frame 735 may either be integrated into the trailer 725 or may be configured to be removable with the turbine 705. In this instance, the frame 735 pivots, allowing the turbine 705 to move from horizontal orientation to vertical orientation, and from vertical orientation to horizontal orientation. Additionally, the frame 735 may be substantially hollow or may be solid depending on ballasting and system 700 requirements.

FIG. 7B shows a first side view of the reactive turbine system 700 of FIG. 7A. FIG. 7A illustrates the turbine 705 oriented horizontally. The turbine 705 may be oriented horizontally when stored for transport or prior to deployment. The turbine 705 may also be oriented horizontally in the flow of fluid F. Conversely, FIG. 7B illustrates the turbine 705 when oriented vertically. The turbine 705 may be rotated from its horizontal orientation to its vertical orientation when deployed in the flow of fluid F via the frame 735. In FIG. 7B, the system axis 730 is also oriented vertically with respect to the turbine 705 and the trailer 725. Furthermore, in FIG. 7B, respective blade axes 745 of the one or more reactive turbine blades 740 are also oriented vertically with respect to the turbine 705 and the trailer 725.

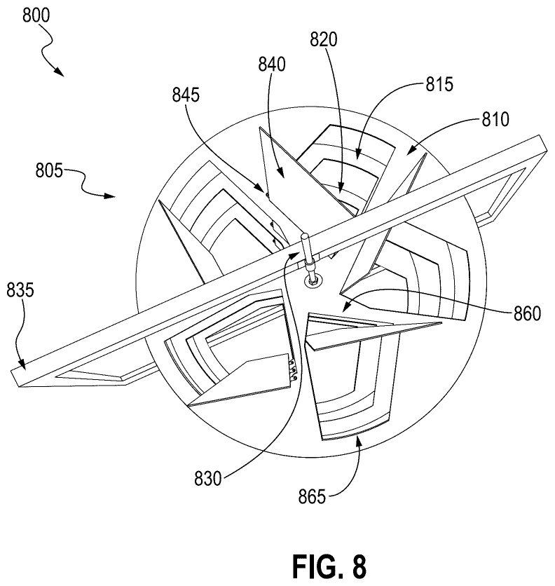

FIG. 8 shows a plan view of a reactive turbine system 800 comprising hollow members. In the present embodiment, the reactive turbine system 800 comprises a turbine 805. Components of the reactive turbine system 800 and the turbine 805 may further comprise hollow members. Such hollow members may include a top support 810, an intermediate support 815, a bottom support 820, a frame 835, a system axis 830, and one or more reactive turbine blades 840. In this embodiment, the turbine 805 rotates about the system axis 830 to produce electrical power and/or pump fluid. Additionally, the one or more reactive turbine blades 840 alternatingly rotate about respective blade axes 845 between a first locking position 860 and a second, opposing locking position 865 when introduced to the fluid environment. In this embodiment, the components, such as the top support 810, the intermediate support 815, the bottom support 820, the frame 835, the system axis 830, and the one or more reactive turbine blades 840, may be hollow such that said components may receive ballast selected from the group consisting of helium, pressurized air, foam, water, lead, and combinations thereof. Ballast can serve to either increase buoyancy or decrease buoyancy of the system 800. Advantageously, ballast assists in moving the system 800 vertically within a fluid column to optimize performance.

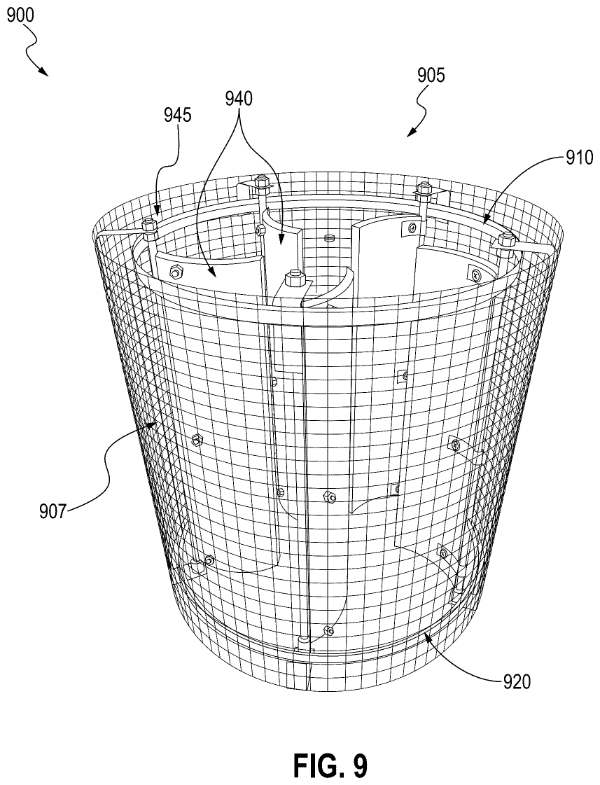

FIG. 9 shows a perspective view of a reactive turbine system 900 comprising a guard 907 in one embodiment. In the present embodiment, the reactive turbine system 900 comprises a turbine 905 disposed within a guard 907. The turbine 905 may further comprise one or more reactive turbine blades 940 and respective blade axes 945 for each of the one or more reactive turbine blades 940. Furthermore, the guard 907, which may rotate with the turbine 905, may further embody both a first and second locking position. Similar to previously described embodiments, the first and second locking positions reverse a direction of rotation of the one or more reactive turbine blades 940 in the flow of fluid F. In this embodiment, the guard 907 may serve as either or both the first and second locking positions. Further, the guard 907 disposed about the turbine system 900 may serve to prevent debris, such as refuse, organic matter, and other suspended media, from entering the turbine system 900. In addition, the turbine 905 of the present embodiment comprises a top support 910 and an opposing bottom support 920.

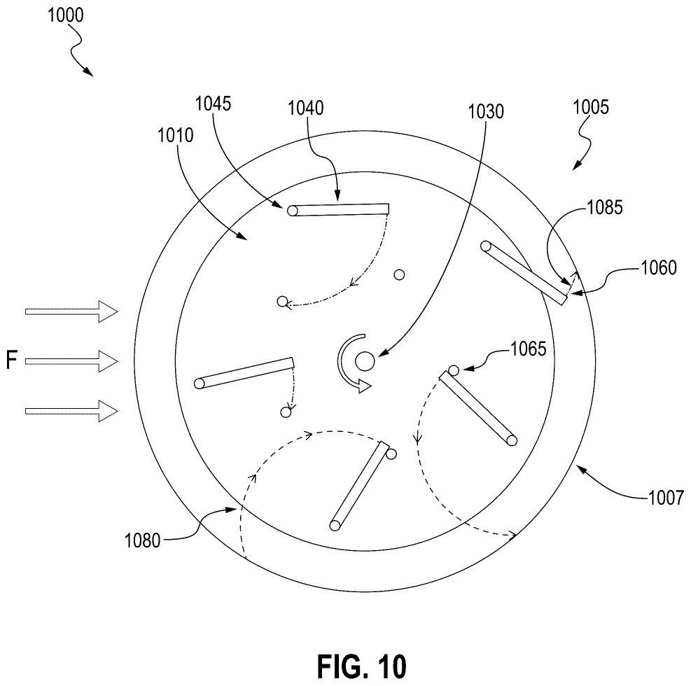

FIG. 10 shows a top-down illustrative view of a reactive turbine system 1000 in one embodiment. In the present embodiment, an operation of the reactive turbine system 1000 is shown. Here, the reactive turbine system 1000 comprises a turbine 1005, wherein the turbine 1005 further comprises a top support 1010, a system axis 1030, one or more reactive turbine blades 1040 and a respective blade axis 1045 for each of the one or more reactive turbine blades 1040. In FIG. 10, bottom and intermediate supports are removed for illustrative purposes. The turbine 1005 of the present embodiment may further comprise a first locking position 1060, a second locking position 1065, and a guard 1007. In this embodiment, the guard 1007 serves as the first locking position 1060, whereas internal components within the turbine 1005 serve as second locking positions 1065. This illustrative view of FIG. 10 demonstrates that the turbine 1005 may be configured for communication with a flow of fluid F, wherein the one or more reactive turbine blades 1040, spinning in a first direction 1080 in the flow of fluid F, reaches the first locking position 1060 and reverses until, spinning in a second, opposing direction 1085, reaches the second locking position 1065 and reverses again to spin in the second direction 1085 in the flow of fluid F. Further, the reactive turbine system 1000 of the present embodiment comprises the guard 1007 disposed about the turbine 1005, configured to spin independently in the flow of fluid F, whereby the rotations of the guard 1007, the one or more reactive turbine blades 1040, and the turbine 1005 cooperate to produce electrical energy, or alternatively, to pump fluid.

### EMBODIMENTS

### Embodiment 1

A reactive turbine system, comprising a turbine having a top support and a bottom support defining a system axis therebetween, the turbine configured to rotate about the system axis in a flow of fluid, a reactive turbine blade disposed between the top and bottom supports and defining a blade axis, the reactive turbine blade configured for communication with the flow of fluid, wherein the reactive turbine blade, spinning in a first direction in the flow of fluid, reaches a first locking position and reverses until, spinning in a second, opposing direction, reaches a second locking position and reverses again to spin in the second direction in the flow of fluid, and a guard disposed about the turbine and configured to spin independently in the flow of fluid, the rotations of the guard, the reactive turbine blade, and the turbine cooperating to produce electrical energy.

### Embodiment 2

The reactive turbine system of Embodiment 1, further comprising a plurality of reactive turbine blades.

### Embodiment 3

The reactive turbine system of any one of the preceding Embodiments, wherein the flow of fluid is selected from the group consisting of water, air, sewage, oil, steam, and combinations thereof.

### Embodiment 4

The reactive turbine system of any one of the preceding Embodiments, wherein the turbine system is oriented vertically.

### Embodiment 5

The reactive turbine system of any one of the preceding Embodiments, wherein the turbine system is oriented horizontally.

### Embodiment 6

The reactive turbine system of any one of the preceding Embodiments, wherein the top support and the bottom support provide the first locking position of the reactive turbine blade.

### Embodiment 7

The reactive turbine system of any one of the preceding Embodiments, wherein the top support and the bottom support provide the second locking position of the reactive turbine blade.

### Embodiment 8

The reactive turbine system of any one of the preceding Embodiments, wherein the reactive turbine blade rotates 360 degrees about its blade axis between the first locking position and the second, opposing locking position.

### Embodiment 9

The reactive turbine system of any one of the preceding Embodiments, wherein the turbine system alternatingly rotates in a clockwise and counterclockwise directions about the system axis.

### Embodiment 10

The reactive turbine system of any one of the preceding Embodiments, wherein rotation of the reactive turbine blade about the system axis produces electrical power.

### Embodiment 11

The reactive turbine system of any one of the preceding Embodiments, wherein the turbine system is comprised of a material selected from the group consisting of plastics, fabrics, UHMW, metals, composites, wood, and combinations thereof.

### Embodiment 12

The reactive turbine system of any one of the preceding Embodiments, wherein the top support is disposed above a fluid level and the bottom support is disposed below the fluid level.

### Embodiment 13

The reactive turbine system of any one of the preceding Embodiments, further comprising a slip ring disposed between the top support and bottom support, the slip ring permitting independent rotation of the top support and bottom support.

### Embodiment 14

The reactive turbine system of any one of the preceding Embodiments, wherein the top support, disposed above the fluid level, is rotated via air, and the bottom support, disposed below the fluid level, is rotated via water.

### Embodiment 15

The reactive turbine system of any one of the preceding Embodiments, further comprising one or more intermediate supports, the one or more intermediate supports disposed between the top support and the bottom support.

### Embodiment 16

The reactive turbine system of any one of the preceding Embodiments, wherein a perimeter of the top support and bottom support further comprises a toothed gear, the toothed gear of the top support and the toothed gear of the bottom support rotating about the system axis and mating with one or more secondary gears to provide rotation to an external power generator affixed to the one or more secondary gears.

### Embodiment 17

The reactive turbine system of any one of the preceding Embodiments, further comprising cathodic protection to inhibit corrosion of the turbine system.

### Embodiment 18

The reactive turbine system of any one of the preceding Embodiments, wherein the cathodic protection comprises zinc anodes affixed to the turbine system to inhibit corrosion.

### Embodiment 19

The reactive turbine system of any one of the preceding Embodiments, wherein the reactive turbine blade is enlarged via a removably attachable member capable of increasing an area of the reactive turbine blade.

### Embodiment 20

The reactive turbine system of any one of the preceding Embodiments, wherein a thickness of the reactive turbine blade is configurable.

### Embodiment 21

The reactive turbine system of any one of the preceding Embodiments, wherein a number and a size of the plurality of reactive turbine blades is decreased as a depth of the fluid increases.

### Embodiment 22

The reactive turbine system of any one of the preceding Embodiments, wherein the number and the size of the plurality of reactive turbine blades is decreased as a speed of the flow of fluid increases.

### Embodiment 23

The reactive turbine system of any one of the preceding Embodiments, wherein the reactive turbine blade is flat.

### Embodiment 24

The reactive turbine system of any one of the preceding Embodiments, wherein the reactive turbine blade is equipped with magnetic cushioning to control rotation and prevent collision with the turbine system.

### Embodiment 25

The reactive turbine system of any one of the preceding Embodiments, wherein the reactive turbine blade is hollow and comprises internal framing.

### Embodiment 26

The reactive turbine system of any one of the preceding Embodiments, wherein the guard disposed about the turbine system rotates with the turbine system and provides an alternate, second locking position for the reactive turbine blade.

### Embodiment 27

The reactive turbine system of any one of the preceding Embodiments, wherein the system axis further comprises an integral electrical power generator.

### Embodiment 28

The reactive turbine system of any one of the preceding Embodiments, wherein the system axis further comprises a hollow, annular region.

### Embodiment 29

The reactive turbine system of any one of the preceding Embodiments, wherein the hollow, annular region of the system axis receives ballast selected from the group consisting of helium, pressurized air, foam, water, lead, and combinations thereof.

### Embodiment 30

The reactive turbine system of any one of the preceding Embodiments, further comprising hollow framing members.

### Embodiment 31

The reactive turbine system of any one of the preceding Embodiments, wherein the hollow framing members receive ballast selected from the group consisting of helium, pressurized air, foam, water, lead, and combinations thereof.

### Embodiment 32

The reactive turbine system of any one of the preceding Embodiments, wherein the turbine system is further capable of operating under ice.

### Embodiment 33

The reactive turbine system of any one of the preceding Embodiments, wherein the turbine system further comprises one or more stages, the one or more stages separated by respective slip rings to permit independent rotation of the one or more stages.

### Embodiment 34

The reactive turbine system of any one of the preceding Embodiments, wherein the one or more stages are stackable.

### Embodiment 35

The reactive turbine system of any one of the preceding Embodiments, wherein the turbine system is portable.

### Embodiment 36

The reactive turbine system of any one of the preceding Embodiments, wherein the turbine system is portable via a trailer, the turbine being affixed to the trailer and transported to a location via a vehicle.

### Embodiment 37

The reactive turbine system of any one of the preceding Embodiments, wherein the turbine system is integral to the trailer, the turbine system and trailer being deployable in the fluid to produce electrical power.

### Embodiment 38

The reactive turbine system of any one of the preceding Embodiments, wherein the trailer is self-buoyant.

### Embodiment 39

The reactive turbine system of any one of the preceding Embodiments, wherein the reactive turbine blade is removably attachable to the turbine system, the turbine system being portable and deployable by attaching the reactive turbine blade at a desired location.

### Embodiment 40

The reactive turbine system of any one of the preceding Embodiments, wherein the turbine system comprises hollow framing and channeling to accommodate weight adjustment.

### Embodiment 41

The reactive turbine system of any one of the preceding Embodiments, wherein the turbine system is connectable to a battery, the turbine system producing electrical power when rotated by the flow of fluid, the electrical power being stored in the battery.

### Embodiment 42

The reactive turbine system of any one of the preceding Embodiments, wherein the turbine system is connectable to a power grid, the turbine system producing electrical power when rotated by the flow of fluid, the electrical power being transmitted to the power grid.

### Embodiment 43

The reactive turbine system of any one of the preceding Embodiments, wherein the turbine system is directly connectable to a portable electronic device, the turbine system producing electrical power when rotated by the flow of fluid, the electrical power being transmitted to the portable electronic device.

### Embodiment 44

The reactive turbine system of any one of the preceding Embodiments, wherein the turbine system compresses a fluid, the fluid stored in a storage tank, and the fluid retaining potential energy convertible to electrical energy at a specified time.

### Embodiment 45

A method of using a reactive, reversible blade turbine system for electrical energy production, the method comprising deploying the turbine system in a flow of fluid, the turbine system further comprising, a turbine having a top support and a bottom support defining a system axis therebetween, the turbine configured to spin about the system axis in the flow of fluid, a reactive turbine blade disposed between the top and bottom supports and defining a blade axis, the reactive turbine blade configured for communication with the flow of fluid, wherein the reactive turbine blade, spinning in a first direction in the flow of fluid, reaches a first locking position and reverses until, spinning in a second, opposing direction, reaches a second locking position and reverses again to spin in the second direction in the flow of fluid, and a guard disposed about the turbine and configured to spin independently in the flow of fluid, the rotations of the guard, the reactive turbine blade, and the turbine cooperating to produce electrical energy, generating electrical energy from the flow of fluid and turbine system via a power generator, and transferring the electrical energy to a connected energy conversion system, the connected energy conversion system selected from the group consisting of a battery, electric grid, portable electronic device, and combinations thereof.

### Embodiment 46

The method of using a reactive, reversible blade turbine system for electrical energy production of any one of the preceding Embodiments, wherein the reactive turbine blade further comprises a plurality of reactive turbine blades.

### Embodiment 47

The method of using a reactive, reversible blade turbine system for electrical energy production of any one of the preceding Embodiments, further comprising attaching zinc anodes to the turbine system to provide cathodic protection to inhibit corrosion.

### Embodiment 48

The method of using a reactive, reversible blade turbine system for electrical energy production of any one of the preceding Embodiments, further comprising adjusting a size, shape, configuration, and number of the plurality of reactive turbine blades relative to a speed and type of the flow of fluid.

### Embodiment 49

The method of using a reactive, reversible blade turbine system for electrical energy production of any one of the preceding Embodiments, further comprising adjusting buoyancy of the turbine system via ballast removably insertable in hollow framing of the turbine system.

### Embodiment 50

The method of using a reactive, reversible blade turbine system for electrical energy production of any one of the preceding Embodiments, further comprising employing magnetic cushioning to control rotation and prevent unwanted collision of the reactive turbine blade with the turbine system.

### Embodiment 51

The method of using a reactive, reversible blade turbine system for electrical energy production of any one of the preceding Embodiments, further comprising deploying additional stages of the turbine system, each stage capable of independent rotation via slip rings to enable relative rotation between the stages.

As previously stated, detailed embodiments of the present disclosure are disclosed herein; however, it is to be understood that the disclosed embodiments are merely exemplary of the disclosure that may be embodied in various forms. It will be appreciated that many modifications and other variations stand within the intended scope of this disclosure as claimed below. Furthermore, the foregoing description of various embodiments does not necessarily imply exclusion. For example, “some” embodiments may include all or part of “other” and “further” embodiments within the scope of this disclosure. In addition, “a” does not mean “one and only one; ” “a” can mean “one and more than one.

I claim:

1. A reactive turbine system, comprising:
a turbine having a top support and a bottom support defining a system axis therebetween, the turbine configured to rotate about the system axis in a flow of fluid;
a reactive turbine blade disposed between the top and bottom supports and defining a blade axis, the reactive turbine blade configured for communication with the flow of fluid, wherein the reactive turbine blade, spinning in a first direction in the flow of fluid, reaches a first locking position and reverses until, spinning in a second, opposing direction, reaches a second locking position and reverses again to spin in the second direction in the flow of fluid; and
a guard disposed about the turbine and configured to spin independently in the flow of fluid, the rotations of the guard, the reactive turbine blade, and the turbine cooperating to produce electrical energy.

2. The reactive turbine system of claim 1, further comprising a plurality of reactive turbine blades.

3. The reactive turbine system of claim 1, wherein the flow of fluid is selected from the group consisting of water, air, sewage, oil, steam, and combinations thereof.

4. The reactive turbine system of claim 1, wherein the turbine system is oriented vertically.

5. The reactive turbine system of claim 1, wherein the turbine system is oriented horizontally.

6. The reactive turbine system of claim 1, wherein the top support and the bottom support provide the first locking position of the reactive turbine blade.

7. The reactive turbine system of claim 1, wherein the top support and the bottom support provide the second locking position of the reactive turbine blade.

8. The reactive turbine system of claim 1, wherein the reactive turbine blade rotates 360 degrees about its blade axis between the first locking position and the second, opposing locking position.

9. The reactive turbine system of claim 1, wherein the turbine system alternatingly rotates in a clockwise and counterclockwise directions about the system axis.

10. The reactive turbine system of claim 1, wherein rotation of the reactive turbine blade about the system axis produces electrical power.

11. The reactive turbine system of claim 1, wherein the turbine system is comprised of a material selected from the group consisting of plastics, fabrics, UHMW, metals, composites, wood, and combinations thereof.

12. The reactive turbine system of claim 1, wherein the top support is disposed above a fluid level and the bottom support is disposed below the fluid level.

13. The reactive turbine system of claim 1, further comprising a slip ring disposed between the top support and bottom support, the slip ring permitting independent rotation of the top support and bottom support.

14. The reactive turbine system of claim 13, wherein the top support, disposed above the fluid level, is rotated via air, and the bottom support, disposed below the fluid level, is rotated via water.

15. The reactive turbine system of claim 1, further comprising one or more intermediate supports, the one or more intermediate supports disposed between the top support and the bottom support.

16. The reactive turbine system of claim 1, further comprising cathodic protection to inhibit corrosion of the turbine system.

17. The reactive turbine system of claim 1, wherein the reactive turbine blade is enlarged via a removably attachable member capable of increasing an area of the reactive turbine blade.

18. The reactive turbine system of claim 1, wherein a number and a size of the plurality of reactive turbine blades is decreased as a depth of the fluid increases.

19. The reactive turbine system of claim 1, wherein the number and the size of the plurality of reactive turbine blades is decreased as a speed of the flow of fluid increases.

20. The reactive turbine system of claim 1, wherein the reactive turbine blade is flat.
